(19) United States
(12) Patent Application Publication
(10) Pub. No.: US 2025/0342080 A1
(43) Pub. Date: Nov. 6, 2025

(54) VECTOR LENGTH DETERMINATION FOR FAULT-ONLY-FIRST LOADS WITH OUT-OF-ORDER MICRO-OPERATIONS

(71) Applicant: Akeana, Inc., Santa Clara, CA (US)

(72) Inventors: Abhijit Sil, Dublin, CA (US); Hai Ngoc Nguyen, Redwood City, CA (US); Ricardo Ramirez, Sunnyvale, CA (US)

(73) Assignee: Akeana, Inc., Santa Clara, CA (US)

(21) Appl. No.: 19/194,213

(22) Filed: Apr. 30, 2025

Related U.S. Application Data
(60) Provisional application No. 63/640,921, filed on May 1, 2024.
(60) Provisional application No. 63/641,045, filed on May 1, 2024.
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/795,829, filed on Apr. 28, 2025.

(51) Int. Cl. G06F 11/07

(52) U.S. Cl. CPC G06F 11/0793; G06F 11/0724; G06F 11/079

(57) ABSTRACT

Techniques for instruction execution, in a processor supporting vector operations, are disclosed. A processor core is accessed. The processor core supports vector operations and is configured to execute micro-operations. A vector load operation is issued. It includes a first number of vector elements, which is determined by a vector length control (VL) register. The vector load operation is split into a series of micro-operations, in which each micro-operation corresponds to a unique vector element and is assigned an element order value. The micro-operations are executed out of order. At least one fault is detected. An earliest faulting micro-operation is determined, based on the element order value of each of the micro-operations. The VL register is updated, based on the earliest faulting micro-operation. All micro-operations that were assigned an element order value higher than an element order value that was assigned to the earliest faulting micro-operation are cancelled.

### RELATED APPLICATIONS

This application claims the benefit of U.S. provisional patent applications “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, and “Accelerated TAGE Branch Prediction With A TAGE Cache” Ser. No. 63/795,829, filed Apr. 28, 2025.

Each of the foregoing applications is hereby incorporated by reference in its entirety.

### FIELD OF ART

This application relates generally to instruction execution and more particularly to vector length determination for fault-only-first loads with out-of-order micro-operations.

### BACKGROUND

Efficient processors play a significant role in modern products and systems in a variety of ways. Efficient processors consume less power, leading to longer battery life in portable devices and reduced electricity costs in stationary systems. This is especially critical in mobile phones, laptops, and IoT devices that operate on limited power sources. Moreover, efficient processors generate less heat, reducing the need for complex and costly cooling solutions. This is particularly important in compact devices where space is limited, such as smartphones and embedded systems. Additionally, efficient processors help reduce the carbon footprint of electronic devices by lowering overall energy consumption. Thus, efficient processors can contribute to global efforts to mitigate climate change and promote sustainability. Furthermore, lower power consumption and reduced heat generation can result in cost savings for manufacturers and consumers. It can lead to smaller, cheaper cooling solutions, longer device lifespans, and reduced operational costs.

Main categories of processors include Complex Instruction Set Computer (CISC) types and Reduced Instruction Set Computer (RISC) types. In a CISC processor, one instruction may execute several operations. The operations can include memory storage, loading from memory, an arithmetic operation, and so on. In contrast, in a RISC processor, the instruction sets tend to be smaller than the instruction sets of CISC processors, and may be executed in a pipelined manner, having pipeline stages that may include fetch, decode, and execute. Each of these pipeline stages may take one clock cycle, and thus, the pipelined operation can allow RISC processors to operate on more than one instruction per clock cycle.

RISC (Reduced Instruction Set Computer) processors offer several advantages over complex instruction set computer (CISC) processors. RISC processors have a simplified instruction set, which makes them easier to design, program, and optimize. This simplicity leads to faster execution of instructions and better performance for many applications. Moreover, RISC processors are well suited for pipelining, a technique that allows multiple instructions to be executed simultaneously in various stages of the pipeline. The simplicity of RISC instructions makes it easier to implement efficient pipelining, which can further improve performance. Additionally, RISC instructions are often more closely aligned with high-level programming languages, making them easier for compilers to optimize. This can lead to more efficient code generation and better performance for compiled programs. Furthermore, due to their simplified instruction sets and efficient execution, RISC processors are often more energy efficient than CISC processors. This makes them ideal for use in mobile devices and other battery-powered applications. Overall, RISC processors offer a range of benefits including simplicity, performance, efficiency, and scalability, making them a popular choice for a wide range of computing applications.

Integrated circuits (ICs) such as processors may be designed using a Hardware Description Language (HDL). Examples of such languages can include Verilog, VHDL, etc. HDLs enable the description of behavioral, register transfer, gate, and switch level logic. This provides designers with the ability to define levels in detail. Behavioral level logic allows for a set of instructions executed sequentially, while register transfer level logic allows for the transfer of data between registers, driven by an explicit clock and gate level logic. The HDL can be used to create text models that describe or express logic circuits. The models can be processed by a synthesis program, followed by a simulation program to test the logic design. Part of the process may include Register Level Transfer (RTL) abstractions that define the synthesizable data that is fed into a logic synthesis tool which in turn creates the gate-level abstraction of the design that is used for downstream implementation operations.

Efficient processors are essential for improving performance, reducing energy consumption, lowering costs, and enhancing the overall sustainability of modern products and systems. As technology continues to advance, there is a growing emphasis on developing processors that achieve high performance while also providing energy efficiency to meet the diverse needs of various applications and industries.

### SUMMARY

Instruction set architecture (ISA) extensions such as vector operations can be enabled for a processor architecture such as a RISC-V™ processor core. Vector registers in a processor are designed to efficiently handle operations on multiple data elements simultaneously. These registers enable a single instruction to operate on multiple data elements, which is particularly beneficial for tasks that involve large datasets, multimedia, matrix algebra, parallel processing, and so on. The vector registers can support addition and/or subtraction of corresponding elements of two vectors, producing a new vector as the result. Additionally, other operations, including, but not limited to, vector multiplication, vector division, vector dot product, vector shifts, and/or other operations, can be supported with vector registers. Furthermore, the vector operations can include vector load and store operations, to enable loading data from memory into the register or storing data from the register back to memory.

Disclosed embodiments address the issue of page faults with vector load operations by providing techniques for determining a vector length with out-of-order micro-operations. A vector operation is split into multiple micro-operations. The micro-operations may be processed out of order. The out-of-order processing may be a result of compiler optimizations, resource utilization issues, dependency delays, and so on. In a case where loading the first element (element 0) of a vector register results in a page fault, then normal page fault processing is performed via a memory management unit (MMU) and/or cache hierarchy. The processing of a page fault is referred to as Fault-Only-First Load (FOFL). In a case where loading the first element (element 0) of a vector register does not result in a page fault, but another element (element >0) results in a page fault, then all the elements prior to the first page fault are loaded into the vector register, and a vector length control (VL) register is updated with the proper vector length. As an example, with a 64-bit vector register, indexed from 0 to 7 (bytes), if the loading of index 6 causes a page fault, then vector elements from 0 to 5 are loaded into the vector register, and the corresponding VL register is set with a value of 6. Accordingly, disclosed embodiments provide improvements in implementation of FOFL instructions of an ISA.

A computer-implemented method for instruction execution is disclosed comprising: accessing a processor core, wherein the processor core supports vector operations, and wherein the processor core is configured to execute micro-operations; issuing, by the processor core, a vector load operation, wherein the vector load operation includes a first number of vector elements, wherein the first number of vector elements is determined by a vector length control (VL) register; splitting the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value; executing the series of micro-operations; determining an earliest faulting micro-operation, wherein the earliest faulting micro-operation is detected within the series of micro-operations, and wherein the determining is based on the element order value of each micro-operation within the series of micro-operations; and updating the VL register, wherein the updating is based on the earliest faulting micro-operation. In embodiments, the executing occurs out of order. In embodiments, the executing includes detecting at least one fault in at least one micro-operation in the series of micro-operations. Some embodiments comprise cancelling all micro-operations in the series of micro-operations that were assigned an element order value higher than an element order value that was assigned to the earliest faulting micro-operation.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for vector length determination with out-of-order micro-operations.

FIG. 2 is a flow diagram for sequencing micro-operations.

FIG. 3 is a block diagram of a multicore processor.

FIG. 4 is a block diagram of a pipeline.

FIG. 5 shows a micro-operation example.

FIG. 6 is an example of a unit-stride non-segmented load with an earliest faulting micro-operation.

FIG. 7 is a second example of a unit-stride load with an earliest faulting micro-operation.

FIG. 8 is an example of a unit-stride segment load with micro-operations.

FIG. 9 is a system diagram for vector length determination with out-of-order micro-operations.

### DETAILED DESCRIPTION

The performance of one or more processors in a given device directly impacts the performance and utility of the device. Common processor device applications include mobile and handheld devices, wearable devices, consumer electronics, automotive electronics, edge computing, and Internet of Things (IoT), to name a few. For one class of processors that includes RISC processors, efficient instruction execution plays a critical role in overall processor performance. Use of a pipeline, or “pipelining,” can reduce the time it takes to execute instructions. This technique enables the processor to initiate processing of a next operation before the previous operation has completed. Shortening the execution time of individual operations translates to faster overall program execution. The processor can also include out-of-order (OoO) processing, which enables the processor to issue instructions into an execution pipeline when operands are available, even if the issuing causes them to execute out of program order. When completed, the processor can retire the instructions in program order. Pipelining an OoO execution can increase the efficiency of modern microprocessors.

Some instructions, especially within vector processing, can be extremely complex and can require multiple levels of logic to implement. To execute more efficiently within a processor pipeline, the vector operations can be split into a series of micro-operations. The micro-operations can execute out of order. In a usage example, each micro-operation can include the same operation on different vector elements within the vector operands. The micro-operations can be numbered so that the processor can retire the micro-operations in program order to generate results of the single vector operation. During the execution of the series of micro-operations, an exception can occur. The exception can include a runtime exception, an illegal operation, and so on. The exception can be processed by the processor, and execution of the series of micro-operations can proceed following the last micro-operation (as determined by numbering) that was successfully completed before the exception occurred.

Additional complications can arise from the use of micro-operations. For example, vector operations can include updating a vector length (VL) control register. The VL register can control the overall number of vector elements that are represented by the data within a vector register. Thus, the number of vector elements that the processor recognizes within the vector registers can change from instruction to instruction. The VL register can also be affected by a memory fault which can prevent a vector load instruction from executing. For example, a vector load instruction can be replaced with a series of micro-operations for efficient execution. During execution, one of the micro-operations can cause a memory fault such as a page fault. With a cache memory system, a page fault occurs when the processor requests a memory address that is not present in the cache. This means that the data or instruction the processor needs is not currently stored in the cache and must be fetched from a higher-level memory within a memory hierarchy, such as L2 cache, main memory, or disk storage. When a page fault occurs, the processor typically generates a page fault exception, which is handled by the operating system. Page faults can have a significant impact on performance, as accessing data from higher-level memory is much slower than accessing data from the cache. Page faults can add complications to vector load operations.

For a vector load operation, where data stored in memory is transferred to a vector register, the load operation is split into multiple micro-operations. In one or more embodiments, a micro-operation includes loading a subset of data from memory to a subset of the vector register elements. The micro-operations can be performed out of order with respect to the order of the elements of the vector register. In one or more embodiments, a micro-operation sequencer performs the splitting of the vector instruction. The micro-operation sequencer also performs the determining of an earliest faulting micro-operation among a group of micro-operations that is used for updating a vector length control register value, and also performs the execution of the micro-operations. Accordingly, disclosed embodiments provide improved techniques for processing Fault-Only-First-Load (FOFL) instructions.

Techniques for vector length determination with out-of-order micro-operations are disclosed. For a vector load operation, where data stored in memory is transferred to a vector register, the load operation is split into multiple micro-operations. In one or more embodiments, a micro-operation can include loading a subset of data from memory to a subset of the vector register elements. The subset of data from memory can include a bit, byte, nibble, or other suitable size. The micro-operations can be performed out of order with respect to the order of the elements of the vector register. In one or more embodiments, a micro-operation sequencer performs the splitting of the vector instruction. The micro-operation sequencer can also perform the determining of an earliest faulting micro-operation among a group of micro-operations, where the earliest faulting micro-operation is among the group of micro-operations, and the determining is based on the element order value of each of the micro-operations of the group of micro-operations. The micro-operation sequencer can also perform the execution of the micro-operations. Accordingly, disclosed embodiments provide improved techniques for processing Fault-Only-First-Load (FOFL) instructions.

A vector operation can necessitate a plurality of execution cycles, where the execution cycles can include accessing data storage to obtain data associated with the vector operation. The execution cycles can further include cycles required by the vector operation. Further execution cycles can include accessing storage for storing results of the vector operation. The processor core can split the vector operation into a series of micro-operations, where the micro-operations can be provided to an execution pipeline included in the processor core. While the execution pipeline is executing the micro-operations, an operation exception can be received by the processor core. A micro-operation sequencer within a decode unit within the processor core tracks execution of the series of micro-operations. When an operation exception is received, the micro-operation sequencer saves the last successfully completed micro-operation.

Vector operations are common in many instruction set architectures (ISAs). Vector operations can, with a single instruction, require many individual operations to complete the single instruction. For example, vector operations such as scalar multiplication, vector addition, vector dot product, vector cross product, and so on can involve several steps and complex operations to accurately compute the result of the vector operation. One step can include operand preparation. This step can include alignment of one or more vectors. In one or more embodiments, the actual vector operation can be performed using hardware components including, but not limited to, pipelines dedicated to vector operations. In some embodiments, an iterative or algorithmic approach may be used to execute the vector operation. Since vector operations can include arithmetic operations such as addition or multiplication, the result of the vector operation may contain more bits of precision than a numerical format such as a floating-point format allows. The rounding process can be performed to reduce the precision to the specified format (e.g., single-precision or double-precision). Moreover, a vector operation can include overflow and underflow handling. The vector operation result may lead to overflow (result too large to represent) or underflow (result too small to represent) conditions. These exceptional cases need to be detected and handled. In some cases, the result may be represented as infinity or zero, depending on the specific floating-point standard (e.g., the IEEE 754 standard). Further error handling can include NaN (not-a-number) handling, and/or exception handling. In embodiments, NaN is a special floating-point value used to represent the result of certain operations that do not yield a valid numeric value. NaN provides techniques for the processor to signal that a particular operation has produced an undefined or unrepresentable result. NaN serves as a placeholder to indicate that a computation has failed to produce a meaningful numeric value, for assorted reasons. The final result of the vector operation can be encoded in a chosen format which can be scalar, floating-point, and so on.

Fault-Only-First-Load (FOFL) instructions, also known as “Only Once” or “Fault-Once” instructions, are used in processors to optimize the handling of speculative loads in out-of-order execution. These instructions can be applicable in scenarios where the value of a memory location is expected to remain constant for the duration of a program or a critical section of code. These instructions can also be useful for vector operations. For example, FOFL instructions can be used in vector-based while loops so that when the while loop exits, the load instruction does not read past the end of an array. That is, if the load instruction reads past its intended target, a page fault can result, and the portion of the vector FOFL that caused the page fault can be ignored. FOFL instructions can be a powerful optimization technique that can improve the efficiency of memory accesses in processors by reducing unnecessary loads and improving the performance of speculative execution.

Certain ISAs, such as RISC-V™, can include instructions that update a vector length (VL) control register. The VL register can control the overall number of vector elements that are represented by the data within a vector register. Thus, the number of vector elements that the processor recognizes within the vector registers can change from instruction to instruction. FOFL instructions can be further complicated by the requirement to update the VL register. In this case, the VL register can be updated to the last operation that was successfully executed without a memory fault such as a page fault (unless the first operation caused the fault, in which a trap can be taken to allow the operating system to process the memory fault). Updating the VL register is further complicated when FOFL instructions are executed by a series of OoO micro-operations. Disclosed embodiments provide improvements for updating a vector length register during processing of vector FOFL instructions with micro-operations that can execute out of order.

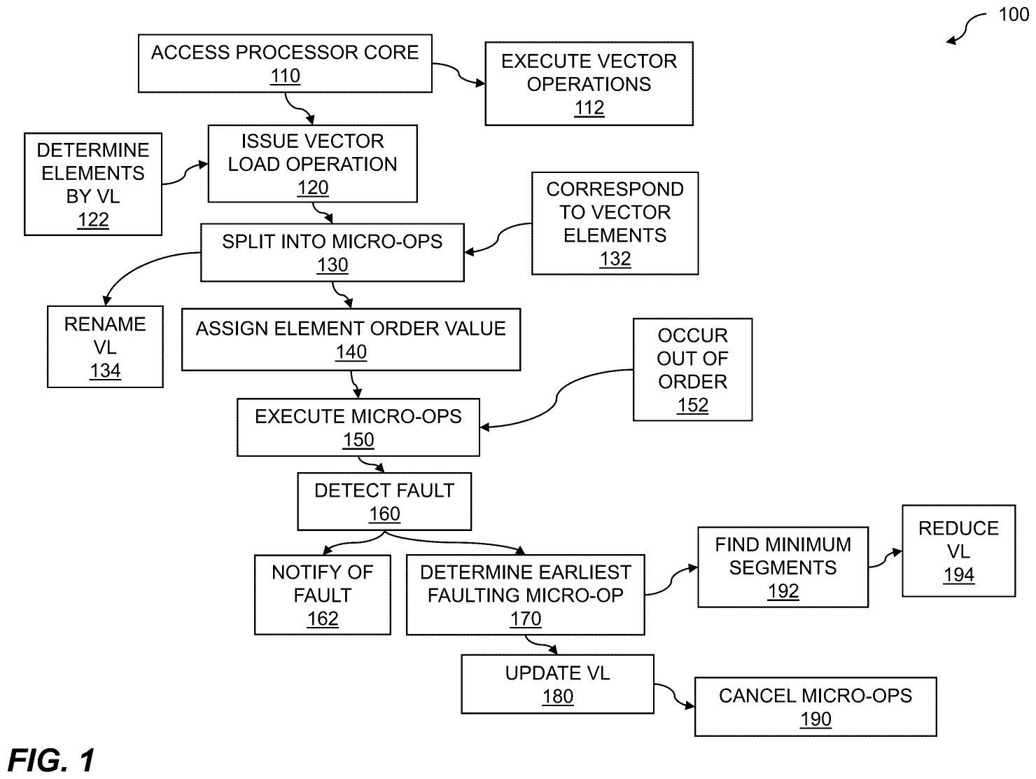

FIG. 1 is a flow diagram for vector length determination with out-of-order micro-operations. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. In embodiments, the processor core can include a RISC-V™ architecture. In the flow 100, the processor core supports execution of vector operations 112. The vector operations can include scalar multiplication, vector addition, determining scalar components of the vector, vector cross product, and so on. In embodiments, a RISC-V™ architecture can include vector extensions. Various vector extensions can be included in the processor core. The extensions can be configurable. Configuration registers can include the ability to control the number of bits in a vector register (vlen), a register grouping multiple (LMUL), a standard element width (SEW), and so on. The configuration registers can be set with a VSET command, the instruction itself, or another method. The vector operations can be based on various numerical precisions such as a scalar, single-precision floating point, double-precision floating point, etc. The processor core includes an execution pipeline, wherein the execution pipeline is configured to execute micro-operations. The processor core can be capable of executing instructions out of order. The processor can include one or more pipelines to execute vector instructions. As discussed below, the vector operation can be split into micro-operations for execution.

The flow 100 includes issuing, by the processor core, a vector load operation 120, wherein the vector load operation includes a first number of vector elements, wherein the first number of vector elements is determined by a vector length control (VL) register 122. The issuing a vector load operation can be based on obtaining the vector operation from storage. The storage from which the vector operation is obtained can include an instruction cache associated with the processor core. The vector load operation that is issued can be based on a program counter associated with the processor core. The vector load operation can require a plurality of execution cycles to execute. The plurality of cycles can be based on architectural cycles associated with the processor core, system clock cycles, processor core clock cycles, etc. In embodiments, the vector load operation comprises a unit-stride fault-only-first non-segment load instruction. In other embodiments, the vector load operation comprises a unit-stride fault-only-first segment load instruction, wherein each micro-operation loads one or more vector data segments into a plurality of vector registers. The unit-stride fault-only-first segment load can be included in instruction set architectures (ISAs) such as RISC-V™. The VL register can determine how many elements were loaded by the vector load instruction into a target vector register. In one or more embodiments, the value in the VL register can be updated based on the results of the vector load instruction. For example, the VL register can be updated based on the occurrence of a memory fault, such as a page fault, that occurs during a vector load operation.

The flow 100 includes splitting the vector operation 130 into a series of micro-operations, wherein each micro-operation in the series of micro-operations corresponds to a unique vector element 132 in the first number of vector elements, and wherein the splitting includes assigning 140, to each micro-operation in the series of micro-operations, an element order value. A vector operation can be split into two or more micro-operations. In embodiments, the number of micro-operations can include a power of two. The splitting can be accomplished using a micro-operation sequencer within a decode unit of the processor core. In embodiments, the assigning is performed by the micro-operation sequencer. The micro-operation sequencer is described below. The splitting by the micro-operation sequencer can be accompanied by a variety of techniques that can keep track of the micro-operations. In the flow 100, each micro-operation in the series of micro-operations corresponds to a unique vector element 132. The element order value can show the order of the micro-operation in the series of micro-operations and can be used to determine the order to retire the series of micro-operations. For example, a first micro-operation can be assigned to element 0 of a vector, a second micro-operation can be assigned to element 1 of the vector, and so on. In general, micro-operation i corresponds to the i^{th} element of a vector register. Each unique vector element can be identified by an element order value. The element order value can also be used to determine which micro-operations should be allowed to retire after one micro-operation caused a page fault. In one or more embodiments, the micro-operation sequencer can use the element order value to uniquely identify a series of micro-operations associated with a vector operation, as well as to identify a particular vector element as corresponding to a specific micro-operation. In embodiments, the micro-operation sequencer can enable the tracking of operational flow among pipeline stages of the execution pipeline of the processor core.

In embodiments, the splitting includes renaming the VL register 134, wherein the renaming includes a plurality of physical registers. The renaming can enable optimizations such as eliminating false data dependencies including write-after-read (WAR) and write-after-write (WAW) dependencies. Such dependencies only depend on the name of a register in multiple instructions, not on data. Thus, physical registers can be used to replace the WAR or WAW dependency in one or more instructions. For operations on vectors, such as addition of vector elements, renaming serves to advance execution by maintaining additional physical copies of registers.

The flow 100 continues with executing the series of micro-operations 150, wherein the executing occurs out of order 152, and wherein the executing includes detecting at least one fault in at least one micro-operation in the series of micro-operations. The series of micro-operations can execute in the processor core via one or more vector pipelines. The series of micro-operations can execute out of order 152, thus allowing some micro-operations to advance out of order with respect to the element order that was assigned. Out-of-order execution can provide additional performance by allowing the processor to find additional parallelism among instructions that can execute in one or more pipelines. Other processing modes are possible, such as in-order execution. The micro-operations can include instructions to cause the processor to load data from a cache within a cache hierarchy into an element of a vector register. The flow 100 includes detecting a fault 160. The fault can include a page fault, and/or another error indicative of data not being present within a page of memory and/or available in the cache hierarchy and/or other intermediate memory location. In embodiments, the page of memory comprises 4K in size. In other embodiments, the page of memory comprises 8K in size, or any other size that is a power of 2. In some embodiments, the detecting is accomplished by a load-store unit (LSU) within the processor core. The flow 100 includes notifying the micro-operation sequencer, by the load-store unit (LSU), of the at least one fault 162. In one or more embodiments, the LSU may notify the micro-operation sequencer of multiple faults.

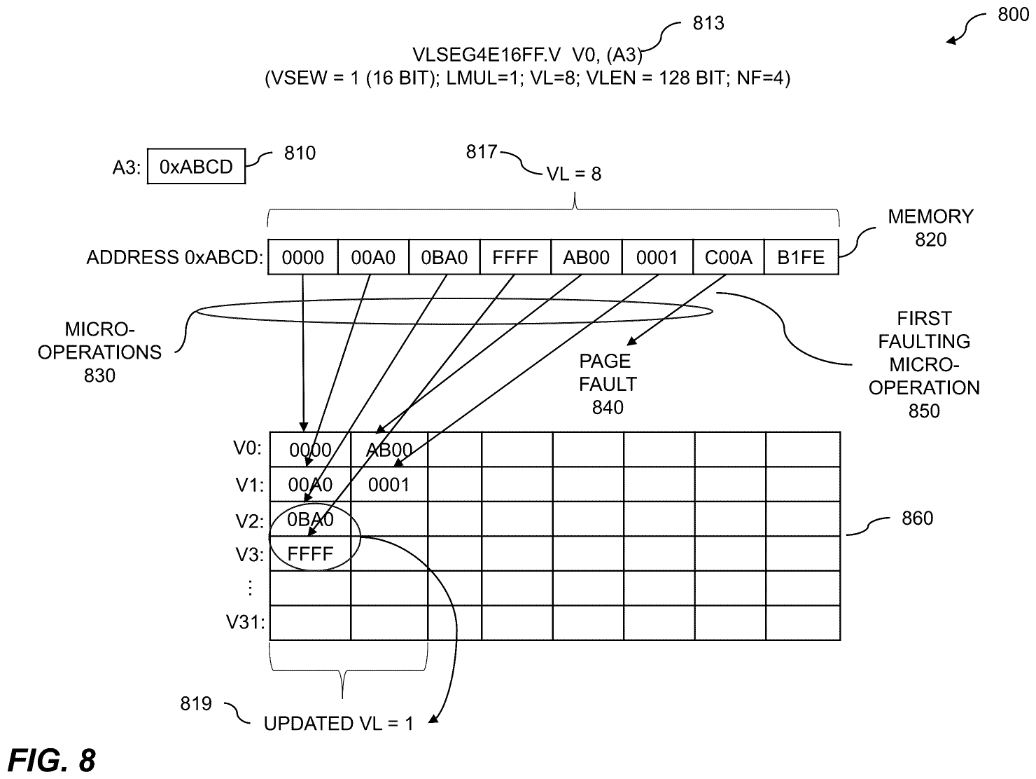

The flow 100 includes determining an earliest faulting micro-operation 170, wherein the earliest faulting micro-operation is within the series of micro-operations, and wherein the determining is based on the element order value of each micro-operation of the series of micro-operations. In this context, the “earliest faulting micro-operation” refers to the micro-operation corresponding to the lowest value ordinal index of the vector register. As an example, if, during a vector load operation, the LSU notifies the micro-operation sequencer that a page fault occurred on loading of vector element 13, vector element 14, and then vector element 11, the “earliest faulting micro-operation” refers to vector element 11. The flow 100 continues with updating the VL register 180, wherein the updating is based on the earliest faulting micro-operation. Continuing with the aforementioned example, with vector element 11 as the earliest faulting micro-operation, the value within the corresponding VL register can be set to 11, indicating that the vector register contains valid data in elements 0-10. If the first faulting micro-operation is the first micro-operation in the series (vector element 0), the memory fault can be processed, and a VL register is not updated. If the first faulting micro-operation is not the first micro-operation (vector element 0), then each micro-operation prior to the first faulting micro-operation can be completed, and the VL register can be updated accordingly. Thus, in embodiments, the earliest faulting micro-operation is not associated with a first element order value. When implementing a unit-stride non-segment load with micro-instructions, the first faulting load can be determined by examining the micro-operations horizontally within the target register. When implementing a unit-stride segment load with micro-operations, the first faulting load can be determined by examining the results of the target registers vertically first, then horizontally. This will be explained in greater detail in FIG. 8.

The flow 100 includes cancelling all micro-operations 190, in the series of micro-operations, that were assigned an element order value higher than an element order value that was assigned to the earliest faulting micro-operation. The cancelled micro-operations can include micro-operations at or after the earliest faulting micro-operation. In an example, if the vector load is divided into eight micro-operations (ranging from 0-7) to load a 64-bit vector register, and the earliest faulting micro-operation is micro-operation 4, then micro-operations 4-7 can be cancelled. In general, if the i^{th} micro-operation is the earliest faulting micro-operation, then all micro-operations corresponding to an index greater than or equal to i can be cancelled.

In one or more embodiments, the vector load operation comprises a unit-stride fault-only-first load instruction. In other embodiments, the vector load operation comprises a unit-stride fault-only-first segment load instruction, wherein each micro-operation loads one or more vector data segments into a plurality of vector registers. For a unit-stride segment load operation, the flow 100 includes finding, in the plurality of vector registers, a minimum number of vector data segments 192 that were loaded, wherein the minimum number comprises a minimum threshold. The finding of minimum segments can include identifying, among a plurality of vector registers involved in the unit-stride segment load operation, which vector register(s) have the lowest number of valid elements. The flow 100 includes reducing the VL register 194 to the minimum threshold. The reducing of the vector length control (VL) register can include setting the VL register to a value corresponding to the lowest number of valid elements. As an example, in a case where there is a group of vector registers involved in a unit-stride segment load operation, and some of the vector registers of the group have five valid elements, while other vector registers within the group have four valid elements, and other vector registers within the group only have three valid elements, (e.g., due to page faults), then the VL register is set to a value of 3. In general, if m is the minimum valid vector length within the group of vector registers, then the VL register is set to the value of m. In this way, disclosed embodiments can support a variety of FOFL vector operations.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

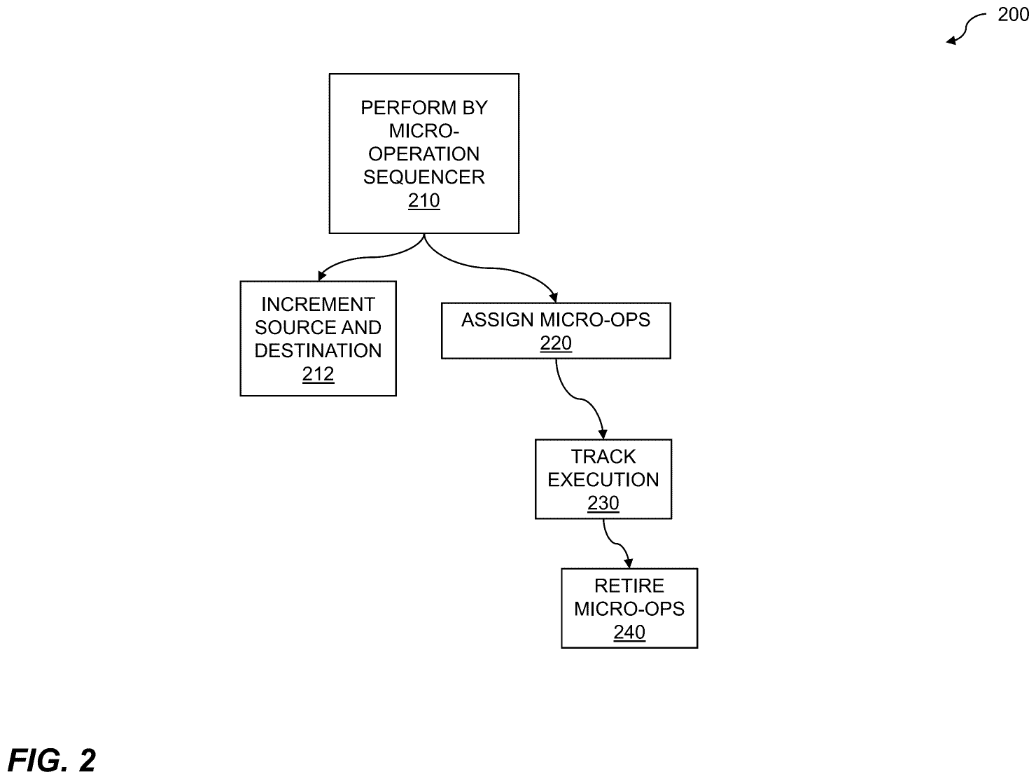

FIG. 2 is a flow diagram for sequencing micro-operations. The flow 200 includes performing operations by a micro-operation sequencer 210. In embodiments, the splitting, the executing, and the determining are performed by a micro-operation sequencer within a decode unit of the processor core. As described above and throughout, the micro-operation sequencer can be used to perform splitting a vector operation into a series of micro-operations, initiating execution of the micro-operations, and completing execution of the micro-operations after processing an operation exception received by the processor core. In the flow 200, the micro-operation sequencer increments 212 source and destination arguments for each of the micro-operations within the series of micro-operations. The incrementing source and destination arguments can ensure that correct data is loaded for each micro-operation and that resulting data is stored for each micro-operation. In a usage example, the source argument can include a source register within the processor core and the destination argument can include a destination register within the processor core. The source register and the destination register can include architectural registers within the processor core. The source register and the destination register can include one or more vector registers.

As described above, embodiments include assigning, to each micro-operation in the series of micro-operations, an element order value. In flow 200, the assigning 220 is performed by a micro-operation sequencer. The assigning can include assigning the series of micro-operations to a processor core. The assigning can include assigning the micro-operations to a pipeline within the processor core, where the pipeline is adapted for vector operations. The flow 200 includes tracking 230, by the micro-operation sequencer, execution of the series of micro-operations. The tracking execution can include determining which micro-operations have completed, which micro-operations have yet to be completed, and so on. The tracking can include associating a micro-operation with an element of a vector register. In embodiments, the micro-operation sequencer can enable the tracking of operational flow among pipeline stages of the execution pipeline of the processor core.

As described above, the executing includes detecting at least one fault in the series of micro-operations. In embodiments, the detecting is accomplished by a load-store unit (LSU) within the processor core. The flow 200 includes retiring 240, by the micro-operation sequencer, all micro-operations in the series of micro-operations that were assigned an element order value less than an element order value that was assigned to the earliest faulting micro-operation. As described previously, the “earliest faulting micro-operation” refers to the micro-operation corresponding to the lowest value ordinal index of the vector register. As an example, if, during a vector load operation, the LSU notifies the micro-operation sequencer that a page fault occurred on loading of vector element 13, vector element 14, and then vector element 11, the “earliest faulting micro-operation” refers to vector element 11. The retiring of a micro-operation can include processing the micro-operation and updating an architectural state accordingly. The architectural state can include an architectural state of a processor, and/or one or more elements within a processor, such as an LSU, micro-operation sequencer, memory management unit (MMU), and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

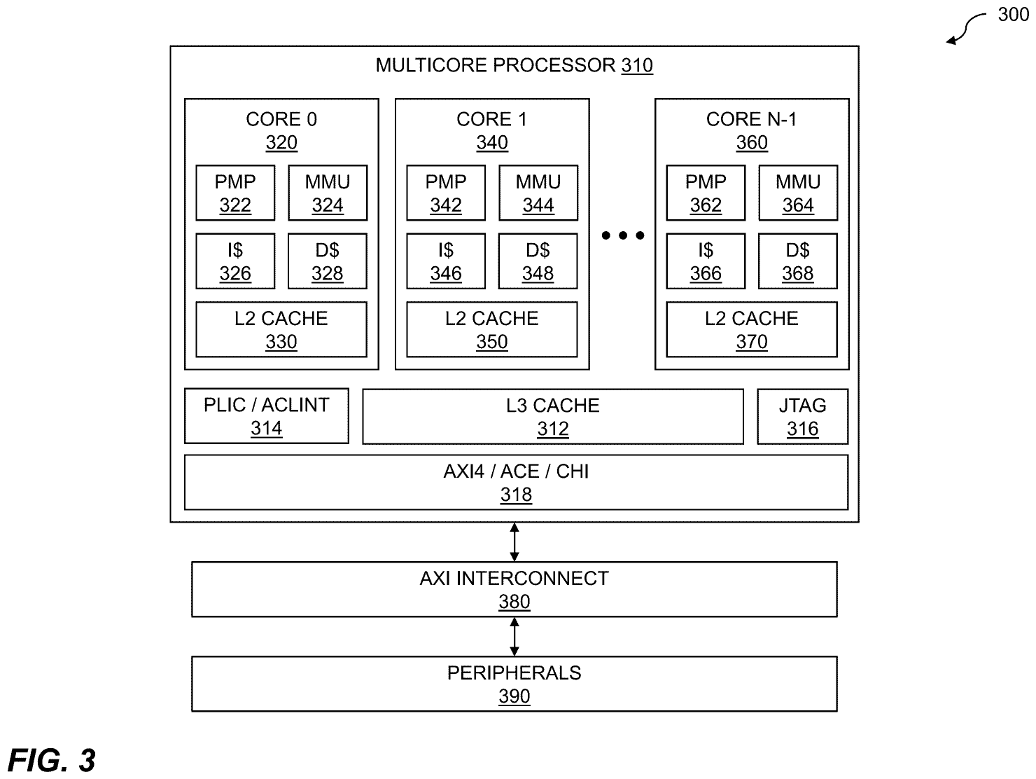

FIG. 3 is a block diagram of a multicore processor. The processor, such as a RISC-V™ processor, ARM processor, or other suitable processor type, can include a variety of elements. The elements can include processor cores including multiprocessor cores, one or more caches, memory protection and management units, local storage, and so on. In embodiments, the processor core sequences vector operations for exception handling. The elements of the multicore processor can further include one or more of a private cache; a test interface such as a joint test action group (JTAG) test interface; one or more interfaces to a network such as a network-on-chip, shared memory, and peripherals; and the like. The multicore processor is enabled by vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core. The vector operation can necessitate a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

In the block diagram 300, the multicore processor 310 can comprise two or more processors, where the two or more processors can include homogeneous processors, heterogeneous processors, etc. In the block diagram, the multicore processor can include N processor cores such as core 0 320, core 1 340, core N−1 360, and so on. Each processor can comprise one or more elements. In embodiments, each core, including cores 0 through core N−1 can include a physical memory protection (PMP) element, such as PMP 322 for core 0; PMP 342 for core 1, and PMP 362 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 324 for core 0, MMU 344 for core 1, and MMU 364 for core N−1. The memory management units can translate virtual addresses used by software running on the cores to physical memory addresses with caches, the shared memory system, etc.

The processor cores associated with the multicore processor 310 can include caches such as instruction caches and data caches. The caches, which can comprise level 1 (L1) caches, can include an amount of storage such as 16 KB, 32 KB, and so on. The caches can include an instruction cache I$ 326 and a data cache D$ 328 associated with core 0; an instruction cache I$ 346 and a data cache D$ 348 associated with core 1; and an instruction cache I$ 366 and a data cache D$ 368 associated with core N−1. In addition to the level 1 instruction and data caches, each core can include a level 2 (L2) cache. The level 2 caches can include L2 cache 330 associated with core 0; L2 cache 350 associated with core 1; and L2 cache 370 associated with core N−1. The cores associated with the multicore processor 310 can include further components or elements. The further elements can include a level 3 (L3) cache 312. The level 3 cache, which can be larger than the level 1 instruction and data caches, and the level 2 caches associated with each core, can be shared among all the cores. The further elements can be shared among the cores. In embodiments, the further elements can include a platform level interrupt controller (PLIC) 314. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 316. The JTAG can provide a boundary within the cores of the multicore processor. The JTAG can enable fault information to a high precision. The high-precision fault information can be critical to rapid fault detection and repair.

The multicore processor 310 can include one or more interface elements 318. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to the interconnect. The interconnect can include a bus, a network, and so on. The interconnect can include an AXI™ interconnect 380. In embodiments, the network can include network-on-chip functionality. The AXI™ interconnect can be used to connect memory-mapped “master” or boss devices to one or more “slave” or worker devices. In the block diagram 300, the AXI interconnect can provide connectivity between the multicore processor 310 and one or more peripherals 390. The one or more peripherals can include storage devices, networking devices, and so on. The peripherals can enable communication using the AXI™ interconnect by supporting standards such as AMBA™ version 4, among other standards.

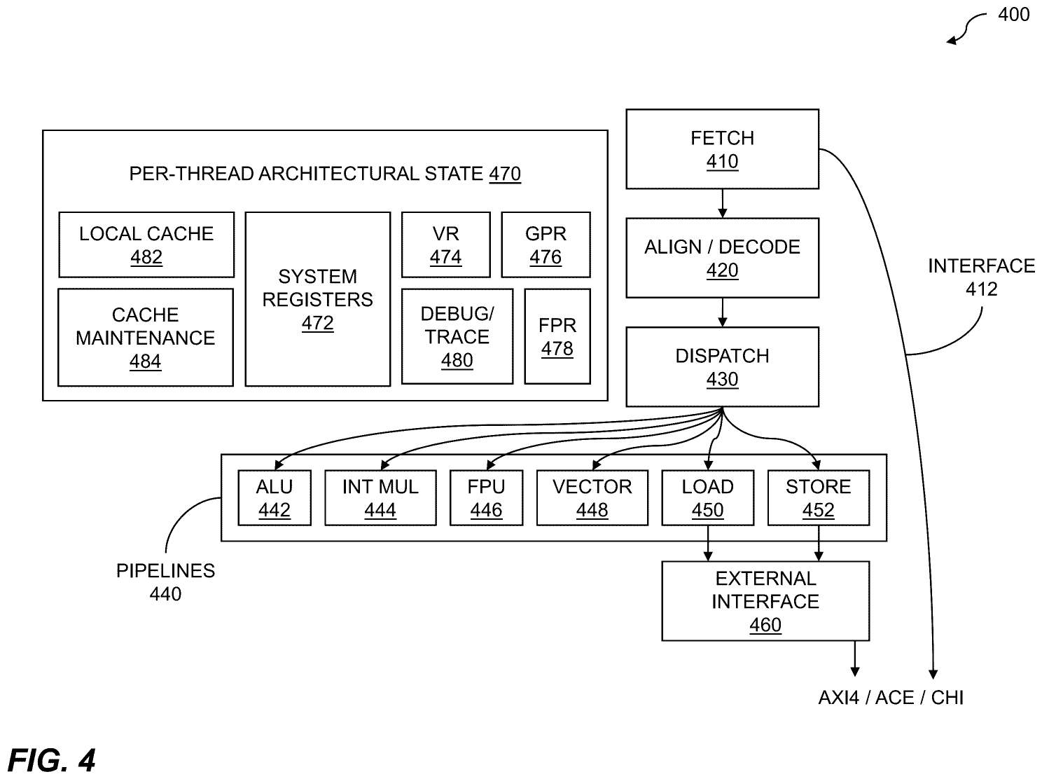

FIG. 4 is a block diagram of a pipeline. The use of one or more pipelines associated with a processor architecture can enhance processing throughput. The processor architecture can be associated with one or more processor cores. The processing throughput can be increased because multiple operations can be executed in parallel. In embodiments, a processor core is accessed, wherein the processor core supports vector operations. The processor core enables vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core. The vector operation can necessitate a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

The blocks within the block diagram can be configurable to provide varying processing levels. The varying processing levels can be based on processing speed, bit lengths, numbers of micro-operations, and so on. The block diagram 400 can include a fetch block 410. The fetch block 410 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 412. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 400 includes an align and decode block 420. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 400 can include a dispatch block 430. The dispatch block can receive decoded instruction packets from the align and decode block. The decoded instruction packets can be used to control a pipeline 440, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 442, integer multiplier pipelines 444, floating-point unit (FPU) pipelines 446, vector unit (VU) pipelines 448, and so on. The dispatch unit can further dispatch instructions to pipelines that can include load pipelines 450, and store pipelines 452. The load pipelines and the store pipelines can access storage such as the common memory using an external interface 460. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 470. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 472. The system registers can be associated with individual processors, a system comprising multiple processors, and so on. The system registers can include exception and interrupt components, counters, etc. The per-thread architectural state can include further registers such as vector registers (VR) 474. The vector registers can be grouped in a vector register file and can be used for vector operations. In embodiments, the width of the vector register file is 512 bits. Additional registers such as general-purpose registers (GPR) 476, and floating-point registers (FPR) 478 can be included. These registers can be used for general purpose (e.g., integer) operations and floating-point operations, respectively. The per-thread architectural state can include a debug and trace block 480. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 482. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 484. The cache maintenance state can include maintenance needed, maintenance pending, and maintenance complete states, etc.

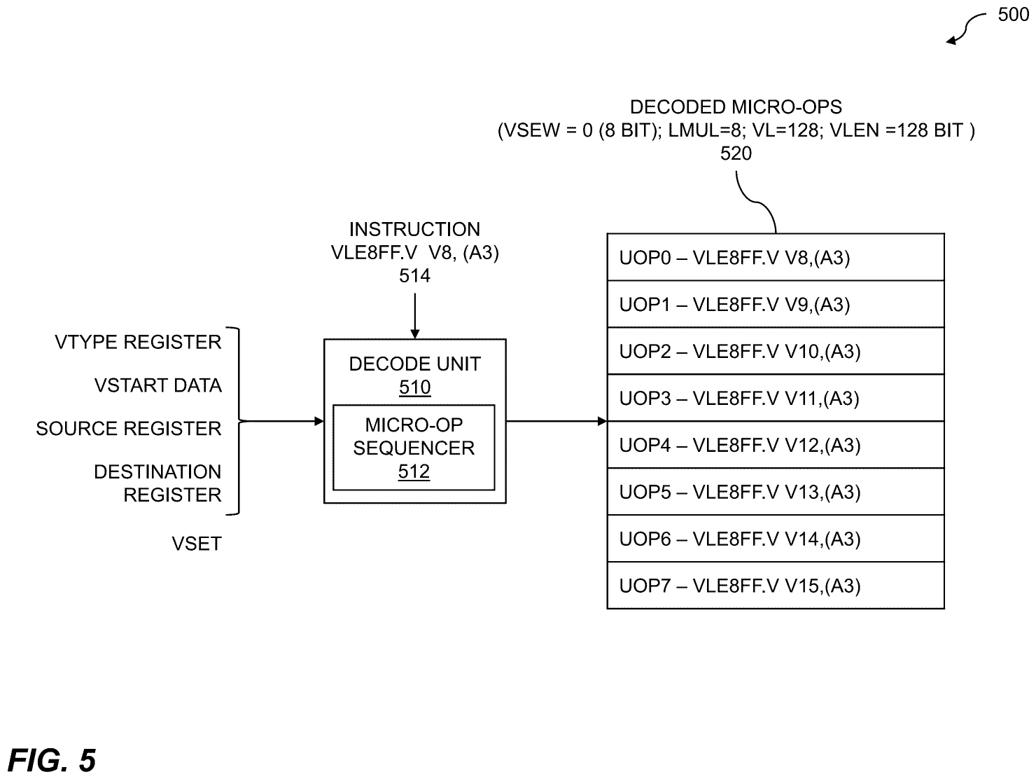

FIG. 5 shows a micro-operation example. Recall that a decode stage associated with a processor core can be used to split an operation such as a vector operation into a series of micro-operations. The micro-operations can include load operations and store operations associated with a vector operation. The micro-operations can be executed, where the execution can be accomplished on a processor core. One of the micro-operations can cause a memory fault. If the first faulting micro-operation is the first micro-operation (e.g., the first element order value), the memory fault can be processed, and a VL register is not updated. If the first faulting micro-operation is not the first micro-operation, then each micro-operation prior to the first faulting micro-operation can be completed, and the VL register can be updated according to the aforementioned techniques. The micro-operations enable vector operation sequencing for memory fault handling. A processor core is accessed, wherein the processor core supports vector operations, wherein the processor core includes an execution pipeline, and wherein the execution pipeline is configured to execute micro-operations. A vector operation is issued, in the processor core. The vector operation can necessitate a plurality of execution cycles. The vector operation is split into a series of micro-operations. An operation exception is received by the processor core. The operation exception is processed. Execution of the series of micro-operations can be completed, based on the timing of the operation exception.

The example 500 shows efficient decoding of an FOFL vector load/store instruction. The decoding is accomplished using a micro-operation sequencer 512. A decode unit 510 can be associated with a processor core (not shown). The decode unit can include a micro-operation sequencer 512. In embodiments, the micro-operation sequencer can assign the series of micro-operations, based on a type of the vector operation. A FOFL vector load operation is shown at 514. As shown in FIG. 5, VLE8FF.V V8, (A3) is an FOFL vector load which writes back 16 elements (for VLEN=128 bit, VSEW=0 (8 bit), for a total of 16×8=128 bits of data written into vector register V8 from the address that is referenced in general-purpose register A3. During the decode of “VLE8FF.V V8 A3”, a micro-operation sequencer logic block will split the single instruction into multiple micro-operations indicated at 520. The vector length control (VL) register is initially set to a value of 128, indicating a vector length of 128 elements. The micro-operation sequencer 512 can be implemented as a finite state machine, which takes inputs such as VTYPE register info (VSEW, LMUL), VSTART data, a source register (VRS2) and destination (VD) register. The micro-operation sequencer logic can ensure that it increments source register(s) and destination register(s) as per requirement of the processor vector specification when it breaks the instruction into individual micro-operations. The processor vector specification can include a RISC-V™ vector specification. In embodiments, the splitting, the executing, and the determining are performed by a micro-operation sequencer within a decode unit of the processor core.

A memory fault, such as a page fault, can occur. For example, a page fault exception can be reported during micro-operation uop4 execution. In this case, once the LSU unit reports the exception to the micro-operation sequencer 512, the VSTART value will be written to an architectural register inside the decoder block during the retirement of uop3. As a result, the vector length control (VL) register, which is initially set to 128, is updated to a value of 64, reflecting that only the first four elements of the vector register, corresponding to uop0-uop3, contain valid data. The above scheme can provide significant performance and power advantages during a variety of exception scenarios.

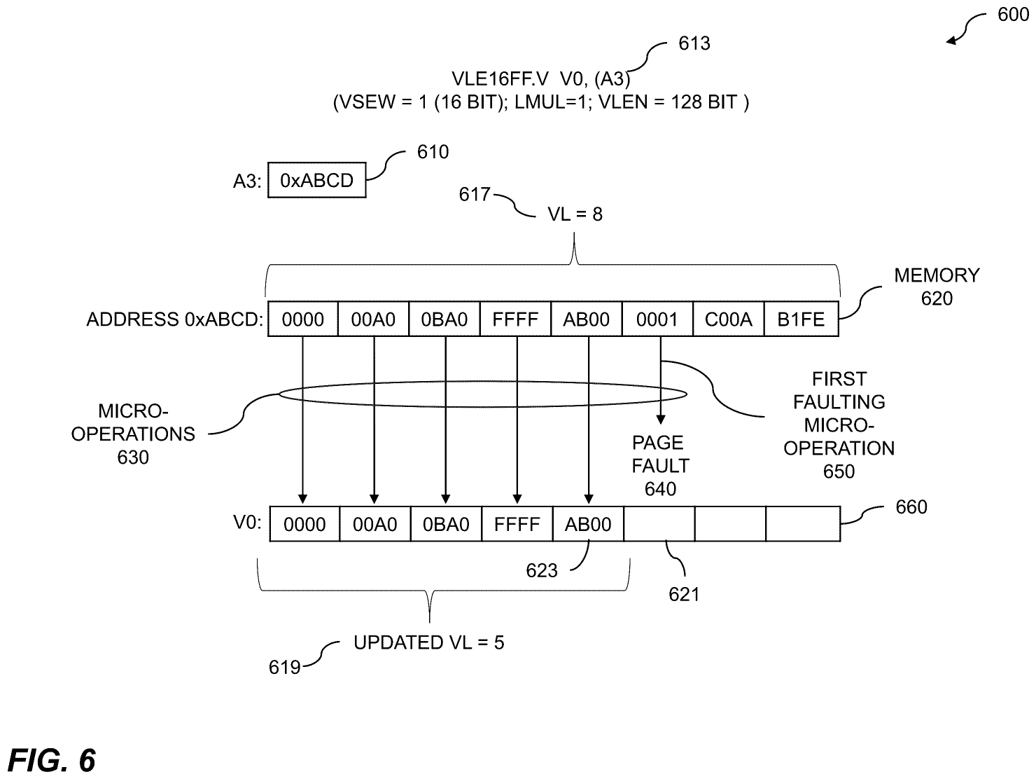

FIG. 6 is an example of a unit-stride load non-segmented with an earliest faulting micro-operation. The example 600 shows additional details of processing an FOFL vector load instruction. A general-purpose register A3, indicated at 610, includes a memory address that serves as a source operand for an FOFL vector load instruction indicated at 613. Configuration values VSEW and LMUL can be part of a VTYPE register. The VSEW value of 1 indicates a 16-bit vector load operation. The LMUL value of 1 indicates a depth of 1 destination register, indicating that all the results are to be written to register V0 660. The memory address location referred to by register A3 is shown at 620. The FOFL vector load instruction indicated at 613 causes a processor and/or micro-operation sequencer to load data from memory 620 into vector register V0, indicated at 660. Prior to execution of instruction 613, the VL register is initially set to a value of 8, as indicated at 617. Micro-operations 630 are performed by a micro-operation sequencer to load data from memory 620 to a corresponding element within vector register 660. A page fault 640 occurs when attempting to transfer data to element 5, indicated at 621. Accordingly, the micro-operation corresponding to element 5 is the first (earliest) faulting micro-operation 650, since the previous element (element 4, indicated at 623) includes valid data. Since micro-operation execution can occur out of order, a situation can occur in which page fault 640 occurs prior to data being transferred to element 4. In this case, the micro-operation sequencer can store the information pertaining to page fault 640, including the corresponding vector element index. When it is determined that elements 0-4 contain valid data, the micro-operation sequencer can determine that the micro-operation that caused page fault 640 is the first (earliest) faulting micro-operation 650, and VL is updated to the value 5, as indicated at 619, thereby efficiently implementing an FOFL vector load instruction. In embodiments, the vector load operation comprises a unit-stride fault-only-first load instruction.

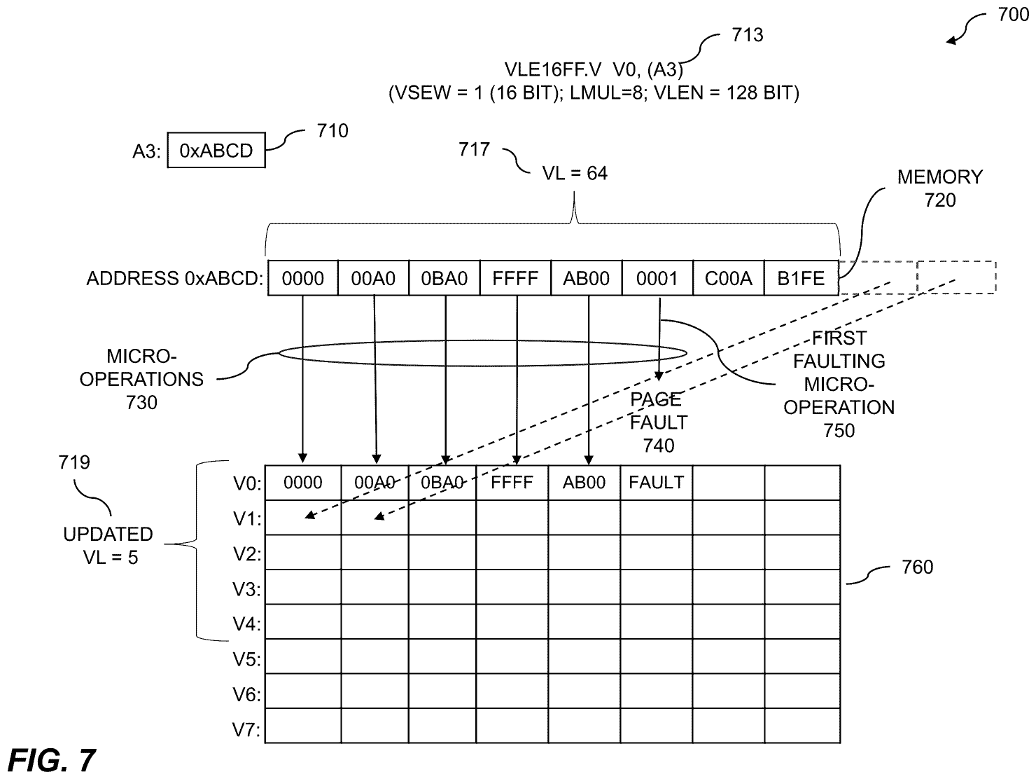

FIG. 7 is a second example of a unit-stride load with an earliest faulting micro-operation. The example 700 shows details of processing an FOFL vector load instruction, indicated at 713. In this example, the value of the LMUL register has a value of 8 (as compared to the example 600 of FIG. 6, where the LMUL register has a value of 1). A general-purpose register A3, indicated at 710, includes a memory address that serves as a source operand for an FOFL vector load instruction indicated at 713. The memory address location referred to by register A3 is shown at 720. The VSEW value of 1 indicates a 16-bit vector load operation. The LMUL value of 8 indicates a depth of eight destination registers, indicating that the data from memory 720 is to be written to the first vector element of the eight corresponding vector registers (V0-V7) of vector register file array 760.

The FOFL vector load instruction indicated at 713 causes a processor and/or micro-operation sequencer to load data from memory 720 to vector register array 760. Note that the next contiguous memory access will also be written into vector register array 760, as illustrated by the dashed line arrows. That is, the first eight elements, each 16 bits (16×8=128 bits), are written to V0. Then the next eight elements are written to V1, then the next eight elements to V2, and so on until V7 is written (LMUL is set to 8, thus a total of eight registers, V0-V7, are written). Prior to execution of instruction 713, the VL register is initially set to a value of 64, as indicated at 717. Micro-operations 730 are performed by a micro-operation sequencer to load data from memory 720 to a first element of a corresponding vector within vector register array 760. A page fault 740 occurs when attempting to transfer data to vector register V0. Accordingly, the micro-operation corresponding to vector register V0 is the first (earliest) faulting micro-operation 750, since the previous register (V4) includes valid data. Since micro-operation execution can occur out of order, a situation can occur in which page fault 740 occurs after data being transferred to other register V1-V7. In this case, the micro-operation sequencer can store the information pertaining to page fault 740, including the corresponding element index. When it is determined that the first five elements of vector registers V0 contain valid data, the micro-operation sequencer can determine that the micro-operation that caused page fault 740 is the first (earliest) faulting micro-operation 750, and VL is updated to the value 5, as indicated at 719, thereby efficiently implementing an FOFL vector unit-stride load instruction. In embodiments, the vector load operation comprises a unit-stride fault-only-first segment load instruction, wherein each micro-operation loads one or more vector data segments into a plurality of vector registers.

FIG. 8 is an example of a unit-stride segment load with micro-operations. The example 800 shows details of processing an FOFL vector unit-stride segment load instruction, indicated at 813. In this example, the instruction “VLSEG4E16FF.V V0, (A3)” causes a unit-stride segment vector load instruction to be performed. The VL register is initially set to a value of 8, as indicated at 817. The VSEW value of 1 indicates a 16-bit vector load operation. As an additional part of the configuration for example 800, an additional register, NF is set to a value of 4. In the RISC-V™ Vector (RVV) extension, the NF (Number of Fields per segment) register is used to specify the number of elements in a vector register. By setting the NF register, the size of vectors used in vector instructions can be configured, enabling efficient parallel processing of data in vectorized operations.

A general-purpose register A3, indicated at 810, includes a memory address that serves as a source operand for an FOFL vector unit-stride segment load instruction indicated at 813. The memory address location referred to by register A3 is shown at 820. The NF register with a value of 4 indicates that the first four elements of the memory 820 are to be written to the first element of each of the first four corresponding vector registers (V0-V3) of vector register array 860. The next four elements of the memory 820 are to be written to the second element of each of the first four corresponding vector registers (V0-V3) of vector register array 860, and so on. Micro-operations 830 are performed by a micro-operation sequencer to load data from memory 820 to elements of a corresponding vector within vector register array 860, based in part on the value set in register NF. However, the micro-operation that is attempting to transfer data to the second element of register V2 causes a page fault 840. The micro-operation sequencer determines that the minimum number of data segments that were loaded is one, as there is only one valid element in vector register V2 and vector register V3. The micro-operation sequencer determines that the micro-operation that caused the page fault is the first faulting micro-operation 850. When implementing a unit-stride segment load with micro-operations, the first faulting load can be determined by examining the target registers vertically first, then horizontally. For example, if both the micro-operations associated with 00A0 and AB00 caused a fault, then the first faulting load would be the micro-operation associated with 00A0, even though AB00 was written in to V0 and 00A0 was written to V1.

Accordingly, the value of VL is updated to 1, as indicated at 819, thereby efficiently implementing an FOFL vector unit-stride segment load instruction. In embodiments, the determining includes finding, in the plurality of vector registers, a minimum number of vector data segments that were loaded, wherein the minimum number comprises a minimum threshold. Embodiments can further include reducing the VL register to the minimum threshold.

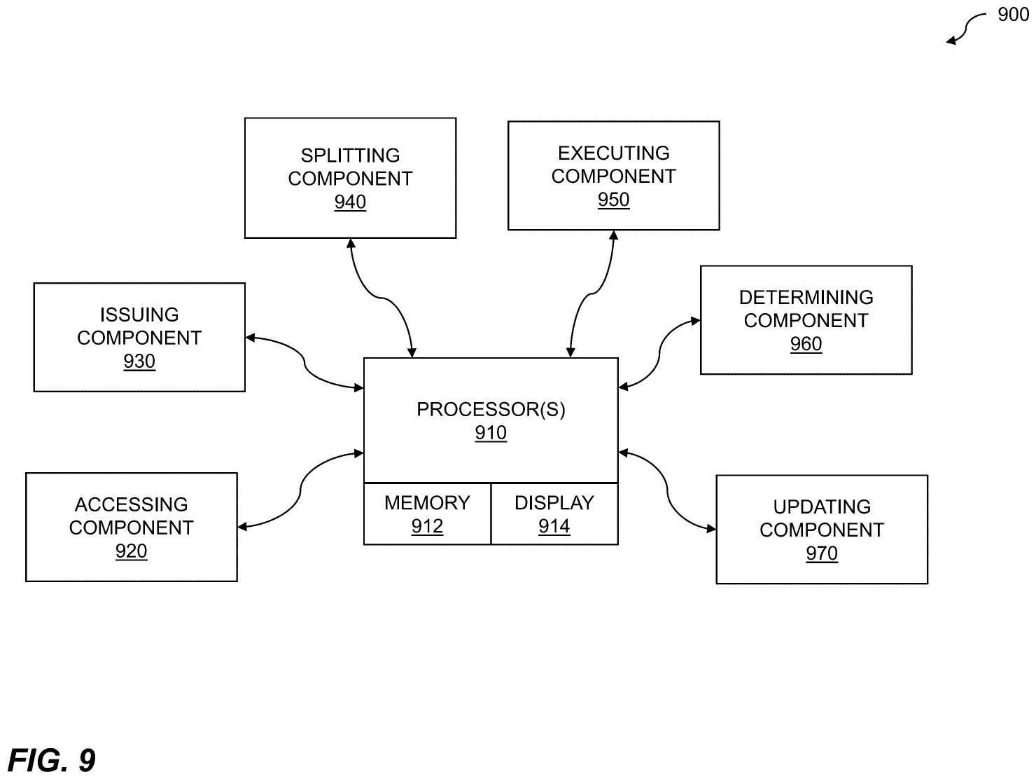

FIG. 9 is a system diagram for vector length determination with out-of-order micro-operations. The system 900 can include instructions and/or functions for design and implementation of integrated circuits that support vector operation sequencing for exception or fault handling. The system 900 can include instructions and/or functions for generation and/or manipulation of design data such as hardware description language (HDL) constructs for specifying structure and operation of an integrated circuit. The system 900 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 900 can include one or more processors 910. The processors can include standalone processors within integrated circuits or chips, processor cores in FPGAs or ASICs, and so on. The one or more processors 910 are coupled to a memory 912, which stores operations. The memory can include one or more of local memory, cache memory, system memory, etc. The system 900 can further include a display 914 coupled to the one or more processors 910. The display 914 can be used for displaying data, instructions, operations, and the like. The operations can include instructions and functions for implementation of integrated circuits, including processor cores. In embodiments, the processor cores can include RISC-V™ processor cores. The system 900 can comprise a system comprising the one or more processors 910, that when executing the instructions which are stored in the memory 912 are configured to: access a processor core, wherein the processor core supports vector operations, and wherein the processor core is configured to execute micro-operations; issue, by the processor core, a vector load operation, wherein the vector load operation includes a first number of vector elements, wherein the first number of vector elements is determined by a vector length control (VL) register; split the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value; execute the series of micro-operations, wherein the executing occurs out of order, and wherein the executing includes detecting at least one fault in at least one micro-operation in the series of micro-operations; determine an earliest faulting micro-operation, wherein the earliest faulting micro-operation is detected within the at least one micro-operation, and wherein the determining is based on the element order value of each of the at least one micro-operations; and update the VL register, wherein the updating is based on the earliest faulting micro-operation.

The system 900 includes an accessing component 920. The accessing component 920 can include functions and instructions for accessing a processor core, wherein the processor core supports vector operations, and wherein the processor core is configured to execute micro-operations. The processor core can include an ARM core, a MIPS core, and/or other suitable core type. In embodiments, the processor core can include a RISC-V™ architecture. The processor core supports vector operations. The RISC-V™ architecture can include extensions, where the extensions can enable execution of various arithmetic and logic operations. In embodiments, the RISC-V™ architecture can include vector extensions. The vector extensions can include a plurality of vector extensions. In embodiments, the vector extensions can include ELEN, VLEN, SEW, LMUL, VLMAX, VL, and VSTART components. The processor core includes an execution pipeline, where the execution pipeline is configured to execute micro-operations. The micro-operations can include accessing a vector register, a starting address for data, a source register, a destination register, and so on.

The system 900 includes an issuing component 930. The issuing component 930 can include functions and instructions for issuing, by the processor core, a vector load operation, wherein the vector load operation includes a first number of vector elements, wherein the first number of vector elements is determined by a vector length control (VL) register. The vector operation can necessitate a plurality of execution cycles. The plurality of execution cycles can be associated with reading or loading data, executing operations such as vector operations on the data, writing or storing data, and so on. In embodiments, the vector operation includes a unit-stride fault-only-first load instruction. In other embodiments, the vector operation includes a unit-stride fault-only-first segment load.

The system 900 includes a splitting component 940. The splitting component 940 can include functions and instructions for splitting the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value. The series of micro-operations can be generated by a decode stage associated with the processor core. The micro-instructions generated by the decode stage can depend on the type of vector operation.

The system 900 includes an executing component 950. The executing component 950 can include functions and instructions for executing the series of micro-operations, wherein the executing occurs out of order, and wherein the executing includes detecting at least one fault in at least one micro-operation in the series of micro-operations. The detected fault can include a page fault. A page fault is an exception that occurs when a program or process attempts to access a page of memory that is not currently mapped to physical memory (RAM), or some memory level within a cache hierarchy. With the FOFL vector load instructions, if the page fault occurs on the attempt to populate the first vector element within a vector register, normal page fault processing occurs, in which the operating system handles the exception by loading the required page from disk into physical memory and updating the memory mapping tables to reflect the new mapping. If instead, the page fault occurs on an element other than the first vector element within a vector register, then the vector register is populated up to the element that caused the page fault, and the VL register is updated to reflect the number of valid elements in the vector register, as described and shown in FIG. 6-8. Thus, in embodiments, the earliest faulting micro-operation is not associated with a first element order value.

The system 900 includes a determining component 960. The determining component 960 can include functions and instructions for determining an earliest faulting micro-operation, wherein the earliest faulting micro-operation is detected within the at least one micro-operation, and wherein the determining is based on the element order value of each micro-operation of the series of micro-operations. In this context, the “earliest faulting micro-operation” refers to the micro-operation corresponding to the lowest value ordinal index of the vector register. In one or more embodiments, a micro-operation sequencer keeps track of various parameters associated with each micro-operation, such as a destination vector index, which indicates an element within a vector register that is to receive data because of executing that micro-operation as part of a vector load instruction.

The system 900 includes an updating component 970. The updating component 970 can include functions and instructions for updating the VL register, wherein the updating is based on the earliest faulting micro-operation. As an example, if the earliest page fault occurs on element 5 of populating a vector register, and elements 0-4 contain valid data, then the VL is set to a value of 5. The VL register is therefore updated to reflect the amount of valid data in a vector register after an FOFL vector operation.

The system 900 can comprise a computer program product embodied in a non-transitory computer readable medium for instruction execution, the computer program product comprising code which causes one or more processors to generate semiconductor logic for: accessing a processor core, wherein the processor core supports vector operations, and wherein the processor core is configured to execute micro-operations; issuing, by the processor core, a vector load operation, wherein the vector load operation includes a first number of vector elements, wherein the first number of vector elements is determined by a vector length control (VL) register; splitting the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value; executing the series of micro-operations, wherein the executing occurs out of order, and wherein the executing includes detecting at least one fault in at least one micro-operation in the series of micro-operations; determining an earliest faulting micro-operation, wherein the earliest faulting micro-operation is detected within the at least one micro-operation, and wherein the determining is based on the element order value of each of the at least one micro-operations; and updating the VL register, wherein the updating is based on the earliest faulting micro-operation.

As can now be appreciated, disclosed embodiments provide improvements to processor performance by implanting FOFL vector instructions using micro-operations. The micro-operations enable vector length determination for vector registers that are not completely loaded, due to exceptions such as a page fault. The FOFL vector instructions enable improved performance for vector operations. Accordingly, disclosed embodiments improve the technical field of instruction execution.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented (processor-implemented) methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core supports vector operations, and wherein the processor core is configured to execute micro-operations;
issuing, by the processor core, a vector load operation, wherein the vector load operation includes a first number of vector elements, wherein the first number of vector elements is determined by a vector length control (VL) register;
splitting the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value;
executing the series of micro-operations;
determining an earliest faulting micro-operation, wherein the earliest faulting micro-operation is detected within the series of micro-operations, and wherein the determining is based on the element order value of each micro-operation of the series of micro-operations; and
updating the VL register, wherein the updating is based on the earliest faulting micro-operation.

2. The method of claim 1 wherein the earliest faulting micro-operation is not associated with a first element order value.

3. The method of claim 1 further comprising cancelling all micro-operations, in the series of micro-operations, that were assigned an element order value higher than the element order value that was assigned to the earliest faulting micro-operation.

4. The method of claim 1 wherein the splitting, the executing, and the determining are performed by a micro-operation sequencer within a decode unit of the processor core.

5. The method of claim 4 wherein the assigning is performed by a micro-operation sequencer.

6. The method of claim 5 further comprising tracking, by the micro-operation sequencer, execution of the series of micro-operations.

7. The method of claim 6 wherein the detecting is accomplished by a load-store unit (LSU) within the processor core.

8. The method of claim 7 further comprising notifying the micro-operation sequencer, by the LSU, of at least one fault.

9. The method of claim 7 further comprising retiring, by the micro-operation sequencer, all micro-operations, in the series of micro-operations, that were assigned an element order value less than an element order value that was assigned to the earliest faulting micro-operation.

10. The method of claim 4 wherein the micro-operation sequencer increments source and destination arguments for each of the micro-operations within the series of micro-operations.

11. The method of claim 1 wherein the splitting includes renaming the VL register, wherein the renaming includes a plurality of physical registers.

12. The method of claim 1 wherein the vector load operation comprises a unit-stride fault-only-first load instruction.

13. The method of claim 1 wherein the vector load operation comprises a unit-stride fault-only-first segment load instruction, wherein each micro-operation loads one or more vector data segments into a plurality of vector registers.

14. The method of claim 13 wherein the determining includes finding, in the plurality of vector registers, a minimum number of vector data segments that were loaded, wherein the minimum number comprises a minimum threshold.

15. The method of claim 14 further comprising reducing the VL register to the minimum threshold.

16. The method of claim 1 wherein the executing occurs out of order.

17. The method of claim 16 wherein the executing includes detecting at least one fault in at least one micro-operation in the series of micro-operations.

18. The method of claim 1 wherein the processor core comprises a RISC-V™ architecture.

19. The method of claim 18 wherein the RISC-V™ architecture includes vector extensions.

20. A computer program product embodied in a non-transitory computer readable medium for instruction execution, the computer program product comprising code which causes one or more processors to generate semiconductor logic for:
accessing a processor core, wherein the processor core supports vector operations, and wherein the processor core is configured to execute micro-operations;
issuing, by the processor core, a vector load operation, wherein the vector load operation includes a first number of vector elements, wherein the first number of vector elements is determined by a vector length control (VL) register;
splitting the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value;
executing the series of micro-operations, wherein the executing occurs out of order, and wherein the executing includes detecting at least one fault in the series of micro-operations;
determining an earliest faulting micro-operation, wherein the earliest faulting micro-operation is detected within the series of micro-operations, and wherein the determining is based on the element order value of each micro-operation of the series of micro-operations; and
updating the VL register, wherein the updating is based on the earliest faulting micro-operation.

21. A computer system for instruction execution comprising:
a memory which stores instructions;
one or more processors coupled to the memory wherein the one or more processors, when executing the instructions which are stored, are configured to:
access a processor core, wherein the processor core supports vector operations, and wherein the processor core is configured to execute micro-operations;
issue, by the processor core, a vector load operation, wherein the vector load operation includes a first number of vector elements, wherein the first number of vector elements is determined by a vector length control (VL) register;
split the vector load operation into a series of micro-operations, wherein each micro-operation in the series of micro-operations corresponds to a unique vector element in the first number of vector elements, and wherein the splitting includes assigning, to each micro-operation in the series of micro-operations, an element order value;
execute the series of micro-operations, wherein the executing occurs out of order, and wherein the executing includes detecting at least one fault in the series of micro-operations;
determine an earliest faulting micro-operation, wherein the earliest faulting micro-operation is detected within the series of micro-operations, and wherein the determining is based on the element order value of each micro-operation of the series of micro-operations; and
update the VL register, wherein the updating is based on the earliest faulting micro-operation.
